(19) United States
(12) Patent Application Publication
(10) Pub. No.: US 2013/0234692 A1
(43) Pub. Date: Sep. 12, 2013

(54) VOLTAGE SUPPLY AND METHOD WITH TWO REFERENCES HAVING DIFFERING ACCURACY AND POWER CONSUMPTION

(71) Applicant: MEDTRONIC, INC., Minneapolis, MN (US)

(72) Inventors: Weizheng Liang, Chandler, AZ (US); Charles R. Gordon, Phoenix, AZ (US); Michael B. Terry, Camas, WA (US); Larry E. Tyler, Mesa, AZ (US); James D. Reinke, Maple Grove, MN (US); Matthew Bond, Tempe, AZ (US); Shohan T. Hossain, Maple Grove, MN (US); Robert M. Ecker, Lino Lakes, MN (US)

(73) Assignee: MEDTRONIC, INC.

(21) Appl. No.: 13/662,884

(22) Filed: Oct. 29, 2012

Related U.S. Application Data
(60) Provisional application No. 61/607,979, filed on Mar. 7, 2012.

(51) Int. Cl. G05F 3/02

(52) U.S. Cl. CPC G05F 3/02
USPC 323/304

(57) ABSTRACT

Voltage supply and method having a first reference and a second reference. The first reference has an operation mode configured to supply a first reference voltage at a first accuracy and consume an operation power and a standby mode configured to consume standby power less than the operation power. The second reference is configured to supply a second reference having a second accuracy less than the first accuracy of the first reference and which consumes a second reference power less than the operation power of the first reference, the second reference voltage being trimmable based, at least in part, on a comparison of the first reference voltage to the second reference voltage.

### FIELD

The present invention relates generally to voltage reference circuits and methods and, in particular, to voltage reference circuits and methods having references for accuracy.

### BACKGROUND

Conventionally, contemporary electronic circuitry often operate on the basis of voltage references. A voltage reference may be configured to produce a voltage output of a particular magnitude relative to a source voltage, often ground. The voltage reference may produce a relatively stable output which may be used by the circuitry to provide particular voltage outputs for powering the circuitry or to operate relative to known parameters. For instance, the output of a voltage reference may be utilized by a power source to provide power at a known ratio to the reference output to power some or all of the electronic circuitry. Similarly, other circuitry may utilize the reference output as a point of reference for conducting logical operations; a comparator, for instance, may make a comparison based on comparing an input with an output of the voltage reference.

But a variety of types of voltage reference circuits incorporate various characteristics. Certain voltage references may consume relatively little power but may provide a relatively unstable output. Conversely, other voltage references may provide relatively stable voltage outputs but may require relatively large amounts of power to do so.

One such stable voltage reference which consumes relatively high power is known in the art as a bandgap reference. A bandgap reference seeks to utilize the bandgap of the substrate on which the bandgap reference is built, conventionally silicon. Because the bandgap of a substance is essentially fixed by physical laws that are constant over temperature, a bandgap reference may produce a comparatively steady and reliable output voltage. In the case of a substrate of silicon, a bandgap reference may tend to produce an output approximately equivalent to the 1.22 electron Volts bandgap of silicon which, depending on the structure of the particular bandgap reference circuit, may tend to be steady in the range of approximately 1.2 to 1.3 Volts.

However, as noted above, bandgap reference circuits tend to consume relatively large amounts of power in comparison to voltage reference circuits which do not depend on a bandgap. In applications with abundant power sources, such relatively large power consumption may be of little consequence. In applications with relatively little available power or in which it may be advantageous to limit power consumption bandgap references may be impractical to use in spite of their steady voltage output.

In particular, implantable medical devices may have internal power sources which either cannot be recharged, perhaps requiring the replacement of the implantable medical device altogether, or which can be recharged only inconveniently. Thus, in such implantable medical device applications, the conventional use of a bandgap reference may result in power depletion levels which may necessitate more frequent medical procedures, including surgical procedures, to continue treating the patient. However, the conventional use of non-bandgap reference circuits may not provide an output voltage suitably stable for reliable operation of the implantable medical device.

### SUMMARY

A voltage reference circuit has been developed which combines a bandgap voltage reference with a lower-power voltage source to provide a relatively stable voltage reference with relatively low power consumption. The bandgap reference is duty cycled so that the bandgap reference is powered on, and thus consuming relatively large amounts of power, only comparatively infrequently. Rather than necessarily being used as a reference voltage for a variety of different components unrelated to the voltage reference circuit, however, the duty cycled bandgap reference output may be utilized instead to adjust the lower-power voltage source.

The lower-power voltage source may be one or more of different, relatively low-power consumption sources. In an embodiment, the voltage source is a low power voltage reference which is relatively unstable over time. The bandgap voltage reference may be configured to provide a reference for a trim circuit which trims the low power voltage reference to compensate for the relative instability of the low power voltage reference. Either alternatively or in supplement to the low power voltage reference, a sample and hold circuit may be charged and periodically refreshed by the bandgap reference based on the decay characteristics of the sample and hold circuit.

While the lower power voltage reference may be relatively unstable over lengthy periods of time, i.e., days or more, the lower power voltage reference may provide adequate stability for periods of time which are nevertheless considerable for electronics applications, i.e., minutes to hours. A voltage reference circuit which incorporates both a bandgap reference and a low power reference may thus turn on the bandgap reference for a period of time only long enough to compare the output of the bandgap reference with the output of the low power reference.

On the basis of the comparison, a trim circuit may trim the low power reference so that the output of the low power reference is approximately equal to that of the bandgap reference. Once the bandgap reference has provided its output sufficient to conduct the comparison, the bandgap reference may disabled. After the trimming is complete, the low power reference provides a reference output approximately equivalent to what the bandgap reference would provide if it were still enabled. In various embodiments, the bandgap reference utilizes a duty cycle of one percent or less in order to provide a relatively stable low power reference.

In an embodiment, a voltage supply comprises a first reference and a second reference. The first reference has an operation mode configured to supply a first reference voltage at a first accuracy and consume an operation power and a standby mode configured to consume standby power less than the operation power. The second reference is configured to supply a second reference having a second accuracy less than the first accuracy of the first reference and which consumes a second reference power less than the operation power of the first reference, the second reference voltage being trimmable based, at least in part, on a comparison of the first reference voltage to the second reference voltage.

In an embodiment, the first reference is a bandgap reference.

In an embodiment, the second reference is a threshold reference.

In an embodiment, the threshold reference is configured with the second accuracy being more accurate with trimming based on the bandgap reference voltage than without trimming based on the bandgap reference voltage.

In an embodiment, the operation mode comprises not more than approximately a one percent duty cycle relative to the standby mode.

In an embodiment, the operation mode comprises a duty cycle based, at least in part, on an environmental factor.

In an embodiment, the environmental factor is temperature.

In an embodiment, the environmental factor is change in temperature.

In an embodiment, the voltage supply is configured to supply the second reference voltage to a load having a voltage accuracy requirement, and wherein the operation mode comprises a duty cycle based, at least in part, on the voltage accuracy requirement of the load.

In an embodiment, the second reference is a threshold reference.

In an embodiment, voltage supply has a voltage reference and a storage circuit. The voltage reference has an operation mode configured to supply a reference voltage at a first accuracy and consume an operation power and a standby mode configured to consume standby power less than the operation power. The storage circuit is configured to store the reference voltage when the voltage reference is in the operation mode and supply an output voltage approximately equivalent to the reference voltage when the voltage reference is in the standby mode, wherein the output voltage is delivered at a second accuracy less than the first accuracy.

In an embodiment, the voltage reference is a bandgap reference configured to supply a bandgap reference voltage.

In an embodiment, wherein the storage circuit supplies the output voltage approximately equivalent to the bandgap reference voltage for a supply duration, and wherein the standby mode operates for not longer than the duration.

In an embodiment, the storage circuit stores obtains the reference voltage during a storage duration, and wherein the operation mode operates for not longer than the storage duration.

In an embodiment, the operation mode comprises not more than a one percent duty cycle relative to the standby mode.

In an embodiment, the operation mode comprises a duty cycle based, at least in part, on an environmental factor.

In an embodiment, the environmental factor is temperature.

In an embodiment, the environmental factor is change in temperature.

In an embodiment, voltage supply has a first reference, a trim circuit, a second reference comparator and a controller. The first reference has an operation mode configured to supply a first reference voltage and consume an operation power and a standby mode configured to consume standby power less than the operation power. The trim circuit is a trim circuit output. The second reference is operatively coupled to the trim circuit and configured to supply a second reference voltage having an accuracy less than an accuracy of the first reference voltage and consume a reference power less than the operation power of the first reference, the second reference voltage being trimmable based, at least in part, on the trim circuit output. A comparator is operatively coupled to the first reference, the trim circuit and the second reference and configured to compare the second reference voltage with a voltage based, at least in part, on the first reference voltage and generate a comparison, wherein the trim circuit output is selectable based, at least in part, on the comparison. The controller is operatively coupled to the first reference and configured to operate the first reference in the operation mode and in the standby mode, with a duty cycle in the operation mode of not greater than approximately one percent. The first reference voltage is supplied to the comparator and the trim circuit provides the trim circuit output to trim the second reference voltage while the first reference is in the standby mode.

In an embodiment, the voltage supply further comprises a storage element, operatively coupled to the bandgap reference and the comparator, configured to store the bandgap reference voltage and supply the bandgap reference voltage to the comparator when the bandgap reference is in the standby mode.

In an embodiment, the storage element is a capacitor.

In an embodiment, the threshold reference has an operation mode and a standby mode and operates in the operation mode on a threshold reference duty cycle.

In an embodiment, the threshold reference duty cycle is at least ten times greater than the duty cycle of the bandgap reference.

In an embodiment, the voltage supply further comprises a storage element operatively coupled to the threshold reference and configured to store the threshold reference voltage and provide the threshold reference voltage when the threshold reference operates in the standby mode.

In an embodiment, the voltage supply further comprises a voltage scaling circuit operatively coupled to the bandgap reference and the comparator and configured to provide an adjusted bandgap reference voltage to the comparator based, at least in part, on the bandgap reference voltage.

In an embodiment, the voltage scaling circuit is a voltage divider.

In an embodiment, the voltage scaling circuit is adjustable and configured to selectively provide one of a plurality of adjusted bandgap reference voltage to the comparator.

In an embodiment, the adjusted bandgap reference voltage is approximately equal to the threshold reference voltage.

In an embodiment, the operation mode comprises a duty cycle based, at least in part, on an environmental factor.

In an embodiment, the environmental factor is temperature.

In an embodiment, the environmental factor is change in temperature.

In an embodiment, the second reference is a threshold reference.

In an embodiment, voltage supply comprises a voltage reference and a storage circuit. The voltage reference has an operation mode configured to supply a reference voltage at a first accuracy and consume an operation power and a standby mode configured to consume standby power less than the operation power. The a storage circuit has a buffer and a capacitive element operatively coupled to the voltage reference and configured to store the reference voltage when the voltage reference is in the operation mode and supply an output voltage approximately equivalent to the reference voltage when the voltage reference is in the standby mode. The output voltage is delivered at a second accuracy less than the first accuracy.

In an embodiment, the voltage reference is a bandgap reference configured to supply a bandgap reference voltage.

In an embodiment, the buffer is a first buffer and wherein the storage circuit further comprises a second buffer operatively coupled to the first buffer and the capacitive element.

In an embodiment, the buffer supplies the output voltage approximately equivalent to the bandgap reference voltage for a supply duration, and wherein the standby mode operates for not longer than the duration.

In an embodiment, the buffer stores the reference voltage during a storage duration, and wherein the operation mode operates for not longer than the storage duration.

In an embodiment, the operation mode comprises not more than a one percent duty cycle relative to the standby mode.

In an embodiment, a method of providing an operation reference voltage has the steps of operating a first reference in an operation mode configured to supply a first reference voltage at a first accuracy and consume an operation power, operating the first reference in a standby mode configured to consume standby power less than the operation power, providing a second reference configured to supply a second reference voltage having a second accuracy less than the first accuracy of the first reference voltage and which consumes a second reference power less than the operation power of the first reference, trimming the second reference voltage based, at least in part, on a comparison of the first reference voltage to the second reference voltage, and providing the second reference voltage as the operation reference voltage.

In an embodiment, the trimming step provides the second accuracy being more accurate with the trimming step based on the bandgap reference voltage than without the trimming step based on the bandgap reference voltage.

In an embodiment, the operating steps comprise a duty cycle based, at least in part, on an environmental factor.

In an embodiment, a method of providing an operation reference comprises the steps of operating a first reference in an operation mode configured to supply a first reference voltage and consume an operation power and in a standby mode configured to consume standby power less than the operation power, supplying a second reference voltage having less accuracy than the first reference voltage and consuming a second reference power less than the operation power, and trimming the second reference voltage based upon a comparison between the first reference voltage and the second reference voltage while operating the first reference in the operation mode. The first reference is operated in the operation mode with a duty cycle of not greater than approximately one percent.

In an embodiment, the method further comprises the steps of storing the bandgap reference voltage and supplying the bandgap reference voltage to the comparator when the bandgap reference is in the standby mode.

In an embodiment, the supplying step has an operation mode and a standby mode and operates in the operation mode on a threshold reference duty cycle.

In an embodiment, the method further comprises the step of providing an adjusted bandgap reference voltage based, at least in part, on the bandgap reference voltage.

In an embodiment, the operating step comprises a duty cycle based, at least in part, on an environmental factor.

### FIGURES

FIG. 1 is a block diagram of a first voltage reference;

FIG. 2 is an exemplary embodiment of the first voltage reference of FIG. 1;

FIG. 3 is a voltage supply utilizing the first voltage reference of FIG. 1 and a second voltage reference;

FIG. 4 is a voltage supply utilizing the first voltage reference of FIG. 1 and a storage circuit;

FIG. 5 is a flowchart for utilizing the voltage supply of FIG. 3; and

FIG. 6 is a flowchart for utilizing a voltage supply.

### DESCRIPTION

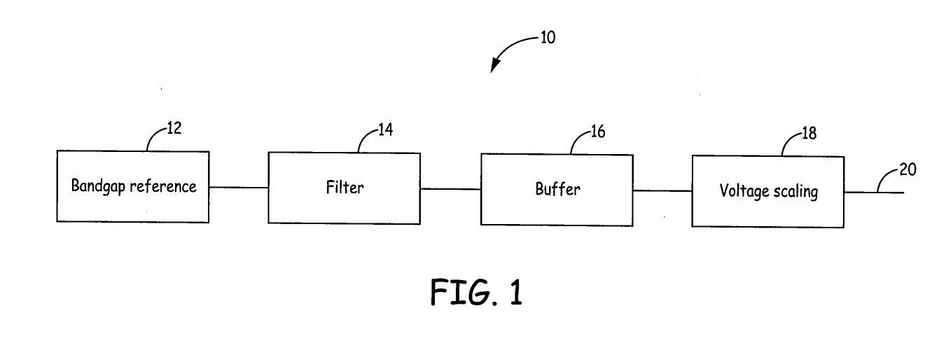

FIG. 1 is a block diagram of a first reference 10. In the illustrated embodiment, first reference 10 includes bandgap reference core 12, filter block 14, buffer 16 and voltage scaling circuit 18. The various blocks 12, 14, 16, 18 of first reference 10 are selectable and configurable based on the needs and requirements of the circumstances in which first reference 10 is utilized.

Bandgap reference core 12 is, in various embodiments, one of various bandgap references well known in the art or a proprietary bandgap reference. In alternative embodiments of first reference 10, voltage references known in the art other than a bandgap reference may be utilized instead of a bandgap reference core, particularly voltage references with relatively stable voltage outputs. Circuitry for bandgap reference core 12 may be configured to produce a relatively reliable output of a first reference voltage at a first accuracy of approximately 1.2 Volts to 1.3 Volts with a variation tolerance of approximately two (2) millivolts over an operational temperature range of bandgap reference core 12. In an embodiment, the variation tolerance of bandgap reference core 12 is approximately one (1) millivolt. Bandgap reference core 12 is configured to be selectively disabled to a standby mode and enabled to an operation mode. As enabled, the first reference voltage output is produced and provided from bandgap reference core 12 to the rest of first reference 10 while consuming an operation power. In various embodiments, the operation power includes an operation current of approximately one hundred (100) nanoAmperes or more. In an embodiment, the operation current is approximately two hundred (200) nanoAmperes. As disabled, the first reference voltage output is not produced while bandgap reference core 12 consumes a standby power having a standby current. In an embodiment, the standby current is approximately six (6) nanoAmperes.

Various bandgap references which may be utilized for bandgap reference core 12 produce noise. In various embodiments, filter block 14 is configured to filter high frequency noise. In various embodiments, buffer 16 is configured to filter low frequency noise and provide a relatively steady output at approximately the output voltage of bandgap reference core 12. Voltage scaling circuit 18 is configured to convert the approximately 1.2 Volt to 1.3 Volt output signal of bandgap reference core 12 to a voltage level useful for the circuitry for which first reference 10 is configured to supply a reference voltage. In certain embodiments, voltage scaling circuit 18 is a voltage divider configured to supply 850 milliVolts on output line 20. In one such embodiment, voltage converter incorporates a low pass RC filter with a resistance of approximately three (3) megaOhms and a capacitance of approximately sixty-five (65) picoFarads. In an embodiment, voltage scaling circuit 18 is a voltage divider configured to supply a selectable output of between 850 and 925 milliVolts on output line 20 through the incorporation of a variable resistor in addition to the low pass RC filter.

Circuitry blocks 12, 14, 16, 18 may be separately selectable and configurable based on the circumstances in which they are utilized. As noted above, bandgap reference core 12 may be selectable based on the characteristics of available bandgap references and other available relatively stable voltage references and the circumstances in which first reference 10 is utilized. Certain bandgap references, including those which have been developed and which may be developed, may have characteristics such as higher or lower current consumption, particular voltage levels and relative amounts of noise which may be advantageous or disadvantageous in certain circumstances. Such bandgap references may be selectable based on such circumstances.

Similarly, certain of filter block 14, buffer 16 and voltage scaling circuit 18 are configurable based on the selected bandgap reference in first reference 10 or may be dispensed with altogether based on the selected bandgap reference or in the event that a requirement of a load for output 20 of first reference 10 does not require the purpose for which each block 14, 16, 18 is directed. For instance, if the selected bandgap reference core 12 produces little high frequency noise, or if the circuitry for which the reference voltage is provided is not susceptible to high frequency noise, then filter block 14 may be excluded. Similarly, filter block 14 may incorporate different types of filters to filter different types of signals. In embodiments in which buffer 16 does not incorporate low frequency filtering, filter block 14 may incorporate low frequency filtering. In various embodiment, buffer 16 may incorporate two or more separate buffers for providing outputs with desired output impedances.

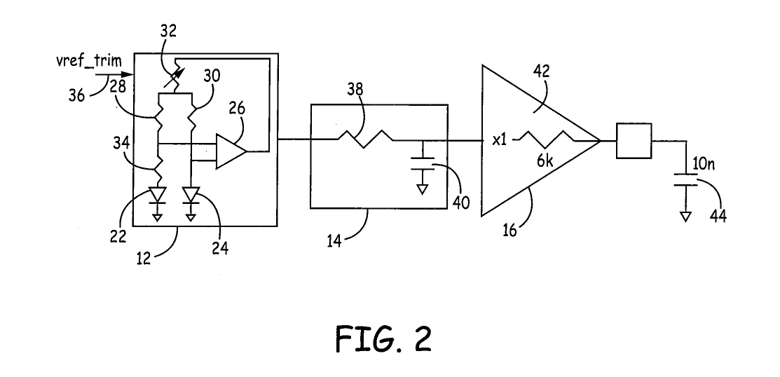

FIG. 2 is exemplary circuitry for a particular embodiment of bandgap reference core 12, filter 14 and buffer 16. In the illustrated embodiment, bandgap reference core 12 produces a reference voltage of approximately 1.2 Volts by summing a base-to-emitter voltage of P-N-P bipolar diodes 22, 24 with a voltage proportionate to absolute temperature, or “PTAT”, created by a difference in voltage between diodes 22, 24 at different current densities. In various embodiments, diode 22 is at least five (5) times larger than diode 24. In an embodiment, diode 22 is nine (9) times larger than diode 24. In such embodiments, the difference in size of diodes 22, 24 provides, at least in part, the difference in current density over diodes 22, 24. In the illustrated embodiment, the voltage difference between diodes 22, 24 arising from the difference in current density over diodes 22, 24 may be calculated according to the equation V=K*(T/Q)*ln(R), where K is Boltzman's constant of 1.38*10⁻²³, T is temperature in degrees Kelvin, Q is the charge on an electron of 1.602*10⁻¹⁹ and ln(R) is the natural logarithm of the ratio between diodes 22 and 24. In an embodiment, the voltage difference between diodes 22, 24 is approximately 56.4 milliVolts at twenty-five (25) degrees Celsius.

In an embodiment, diodes 22, 24 have a diode voltage of approximately 0.5 Volts, but a negative temperature coefficient of approximately 2.3 milliVolts per degree Celsius at thirty-seven (37) degrees Celsius. The difference in current density over diodes 22, 24 may produce a voltage differential proportionate to absolute temperature of approximately 0.7 Volts with a positive temperature coefficient of approximately 2.3 milliVolts per degree Celsius at thirty-seven (37) degrees Celsius. Consequently, summed together, the diode voltage and the voltage proportionate to absolute temperature produce an output voltage of approximately 1.2 Volts; as the positive 2.3 milliVolts per degree Celsius of the voltage proportionate to absolute offsets the negative 2.3 milliVolts per degree Celsius of the diode voltage, the output of bandgap reference core 12 may be substantially temperature independent.

Amplifier 26, resistors 28, 30 and variable resistor 32 provide, at least in part, for the difference of current over diodes 22, 24, the variation of current over diodes 22, 24, and summing of the diode voltage and the voltage proportionate to absolute temperature. Resistor 34 provides the voltage difference between diodes 22, 24. Trim input 36 coupled to variable resistor 32 provides variation of current over diodes 22, 24. In certain embodiments, bandgap reference core 12 is trimmed at production and not trimmed thereafter. In various embodiments, resistors 28, 30 have values of approximately twenty-seven (27) megaOhms and resistor 32 has a value of approximately three (3) megaOhms, while variable resistor 32 is variable from approximately 0.8 megaOhms to approximately 7.3 megaOhms with a resolution of approximately twenty-five (25) kiloOhms producing an output voltage resolution of approximately one (1) milliVolt. Alternatively, variable resistor 32 has a resolution of approximately twenty (20) kiloOhms producing an output voltage resolution of approximately 0.8 milliVolts.

In various embodiments, amplifier 26 is an operational amplifier with a relatively low offset voltage. In one such embodiment, amplifier 26 is a chopper amplifier, as known in the art, to reduce low frequency noise relative to other operational amplifiers known in the art. Offset from amplifier 26 and low frequency noise may further be reduced through a dynamic element matching technique. In the above illustrative embodiment for diode 22 being nine (9) times larger than diode 24, diodes 22 and 24 together comprise ten discrete diodes each configured to be approximately or exactly the size of diode 24. At any give time, diode 22 comprises nine (9) of the discrete diodes switched to be electrically in parallel with respect to one another while diode 24 comprises the remaining one (1) discrete diode. The discrete diodes are periodically switched, in an embodiment with each clock cycle, so that each discrete diode comprises diode 24 in turn. In such an embodiment, over ten switches, diode 24 acts as an average of each of the ten discrete diodes while diode 22 acts as a diode of nine (9) times the average of the ten discrete diodes. In an embodiment, filter 14 may provide filtering against a voltage ripple caused by such dynamic element matching diode switching.

Filter block 14, as illustrated, is configured to filter out high frequency noise. Resistor 38 is approximately twenty (20) megaOhms while capacitor 40 is approximately sixty (60) picoFarads, providing a filter with a low pass filter frequency of approximately one hundred thirty (130) Hertz. As noted above, filter block 14 is configured based on the performance of surrounding circuitry, including the particular bandgap reference core 12 utilized; in alternative embodiments, filter block 14 may be configured as appropriate to filter noise based on particular circumstances.

As illustrated, buffer 16 is an amplifier 42 in a unity gain configuration with six thousand Ohms output resistance. Such a configuration may provide a relatively low impedance output to output capacitor 44, in an embodiment ten (10) nanoFarads, in comparison with other buffer amplifiers known in the art. Amplifiers with different output resistance are contemplated and selectable based on the particular circumstances in which buffer 16 is utilized.

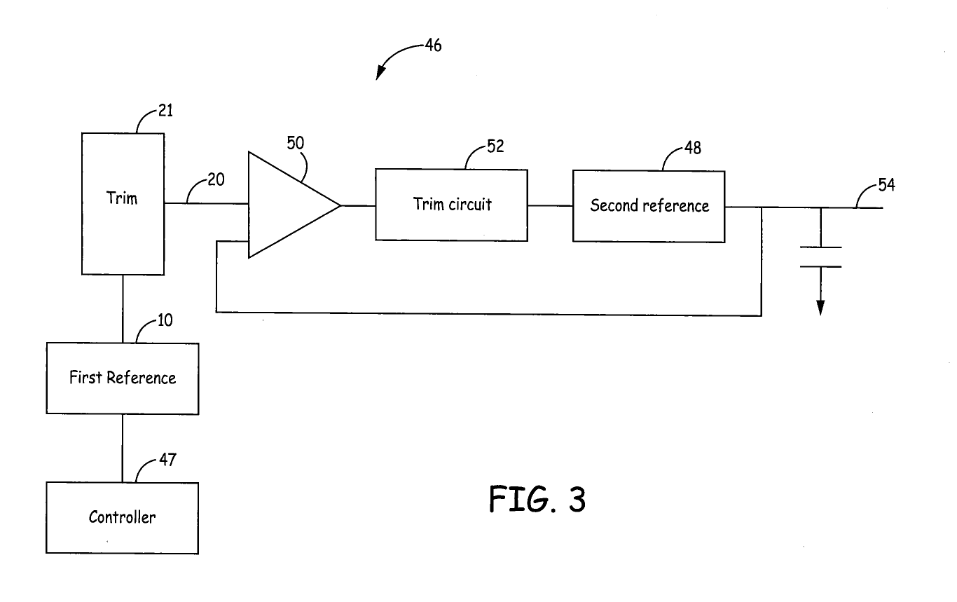

FIG. 3 is an embodiment of voltage supply 46 which utilizes first reference 10 in conjunction with controller 47, second reference 48, comparator 50 and trim circuit 52. In an embodiment, first reference 10 is duty cycled by controller 47 as described above so that first reference 10 consumes a standby power less than the operation power, as discussed above. Second reference 48 provides a reference voltage on output 54 that is approximately equal to the first reference voltage on output 20 of first reference 10 while consuming less power than would be produced by first reference 10 operating alone continuously.

Trim circuit 21 is used to scale the voltage output of first reference 10 from 1.2 Volts to 850 milliVolts and is used as the “minus” input of comparator 50. Comparator 50 compares output 54 against the “minus” terminal and the output to trim circuit 52. Trim circuit 52 adjusts second reference 48 to output the proper voltage on output 54.

In various embodiments, second reference 48 is any trimmable voltage reference which consumes less operational power than first reference 10 and which has a second accuracy less than the first accuracy of first reference 10. In various embodiments, second reference 48 is a CMOS threshold reference as known in the art. In certain such embodiments, second reference 48 is configured to provide a second reference voltage output approximately equal to output 20 of first reference 10. In the above embodiment, second reference 48 is configured to generate a second reference voltage output of approximately 850 milliVolts while consuming a second reference power of approximately fifteen (15) to twenty-one (21) nanoAmperes.

Comparator 50 compares the voltage on output 20 and the output of second reference 48 and supply a result to trim circuit 52. A trim circuit output of trim circuit 52 selectable based on the output of comparator 50 and is supplied to second reference 48 to adjust second reference 48 so that the output of second reference 48 is approximately equal to that of first reference 10. In an embodiment, comparator 50 clocks at approximately four (4) kiloHertz. In an embodiment, non-overlapping phases of the output of comparator 50 may be utilized to sample output 54 of second reference 48, in a first phase, and in a second phase compare output 54 of second reference 48 with output 20 of first reference 10 and output the comparison. In various embodiments, trim circuit 52 is implementable as a field programmable gate array, or “FPGA”, or as analog or digital circuitry.

In various embodiments, first reference 10 is duty cycled at a duty cycle rate. In an exemplary embodiment, first reference 10 consumes approximately two hundred (200) nanoAmperes as a relatively accurate and stable output voltage, in the above embodiment approximately 850 milliVolts, is supplied to output 20. In various embodiments, second reference 48 is not duty cycled regularly, and instead supplies an output 54 to comparator 50 effectively continuously during normal operation. During the time first reference 10 is active, comparator 50 compares output 20 with the output 54 of second reference 48. Trim circuit 52 trims second reference 48 until the output 54 of second reference 48 approximately matches that of output 20.

In various embodiments, first reference 10 is duty cycled at least fifty (50) percent in order to provide a net reduction in total system current consumption relative to operating first reference 10 without second reference 48. In various embodiments, however, first reference 10 is only operated approximately as long as is required to trim second reference 48 to produce an output voltage 54 approximately that of output 20 of first reference 10. In an embodiment, first reference 10 may require approximately ten (10) milliseconds to stabilize after having been enabled, while comparator 50 and trim circuitry 52 may require approximately 0.5 milliseconds to trim second reference 48, resulting in an active duty cycle period of approximately 10.5 milliseconds. In various embodiments, the duty cycle is not more than approximately one (1) percent.

In an embodiment, first reference 10 requires approximately 300 nanoAmperes to operate and has a duty cycle of approximately five percent. By comparison, second reference 48 requires only 20 nanoAmperes to operate resulting in an energy savings of approximately twelve (12) times (25 nanoAmperes versus 300 nanoAmperes).

In various embodiments, first reference 10 is left disabled for as long as second reference 48 may be expected to maintain a stable output voltage. Relative stability of second reference 48 may be assessed both objectively and on the basis of a voltage accuracy requirement of a load to which voltage supply 46 is supplying an output voltage. Such a period of time over which output 54 of second reference 48 maintains a stable output voltage may vary significantly based on the particular second reference 48 utilized, as well as environmental factors such as temperature. In certain embodiments, second reference 48 may maintain a stable output voltage for fifteen (15) minutes or more. However, under variable temperature conditions, the same second reference 48 may produce a stable output voltage for one (1) minute or less. In an embodiment, first reference 10 is disabled for approximately one (1) minute during every duty cycle.

In alternative embodiments, a temperature sensor is incorporated in controller 47 which regulates, at least in part, the duty cycle of bandgap voltage reference 10 based on measured temperature, change in measured temperature over time, and an expected impact on the stability of the output voltage of second reference 48. In such embodiments, first reference 10 may be disabled for fifteen (15) minutes or more during duty cycles where second reference 48 is expected to be relatively stable based on measured temperature.

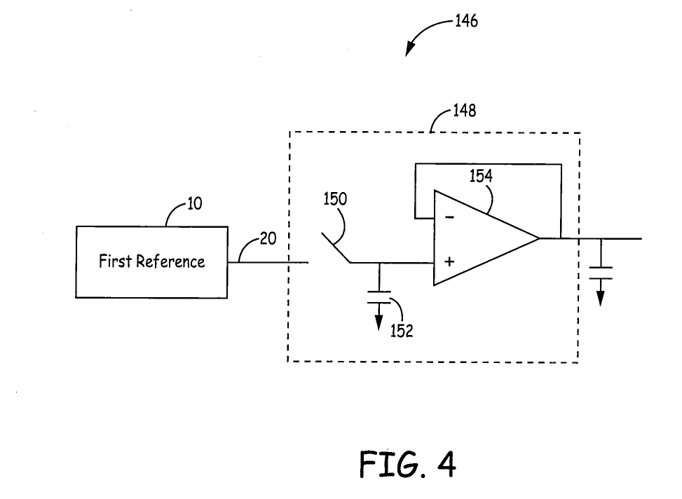

FIG. 4 is an alternative voltage supply 146 incorporating storage circuitry 148. Storage circuitry 148 incorporates switch 150, storage capacitor 152 and operational amplifier 154. Switch 150 is closed during an operation time of voltage reference 10, allowing storage capacitor 152 to charge to the voltage on output 20 of voltage reference 10. Operational amplifier 154 is configured to supply the output voltage of capacitor 152 with a relatively low output impedance. When switch 150 opens, storage capacitor 152 is configured to deliver an output voltage for a supply duration at a second accuracy less than the first accuracy of voltage reference 10, the output voltage being approximately equivalent to the voltage on output 20, during which supply duration storage capacitor 152 gradually discharges.

In various embodiments, storage capacitor 152 is of selectable size based on size constraints and an amount of time it is desired for storage capacitor 152 to deliver the output voltage. In an embodiment, storage capacitor 152 is a seventeen (17) picoFarad capacitor. In such embodiments, storage capacitor 152 supplies a relatively stable output voltage for a supply duration of approximately 1.5 seconds. In such embodiments, voltage reference 10 is disabled for approximately 1.5 seconds and enabled for approximately 10.5 milliseconds, as described above with respect to voltage supply 46 (FIG. 3), providing a duty cycle of not more than approximately one (1) percent. As described in detail with respect to voltage supply 46, environmental factors such as temperature may impact the supply duration of voltage supply 146 as well.

In various embodiments, storage circuitry 148 of voltage supply 146 may be incorporated into voltage supply 46. In various embodiments, output 54 of second reference 48 may be supplemented by storage circuitry 148 adding additional stability and longer operational duration. In other embodiments, including those which incorporate storage circuitry 148 in voltage supply 46, second reference 48 may be duty cycled between an operational mode and a standby mode using a duty cycle based on the duty cycle of a threshold reference. In such embodiments, the threshold reference duty cycle is at least ten (10) times greater than the duty cycle of first reference 10.

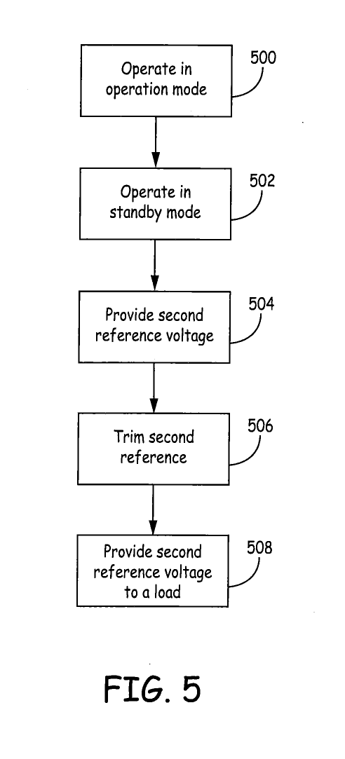

FIG. 5 is a flowchart for providing an operation reference voltage utilizing voltage supply 46. First reference 10 is operated (500) in its operation mode to supply a first reference voltage while consuming an operation power, in the above exemplary embodiment approximately 1.2 Volts and approximately two hundred (200) nanoAmperes, respectively. First reference 10 is operated (502) in a standby mode configured to consume standby power less than the operation power, in the exemplary embodiment approximately six (6) nanoAmperes. Second reference 48 is provided (504) to supply the second reference voltage having a second accuracy less than the first accuracy of first reference 10 and which consumes a second reference power less than the operation power of first reference 10. In the exemplary embodiment, the second reference power is between approximately fifteen (15) and twenty-one (21) nanoAmperes.

Second reference 48 is trimmed (506) by trim circuit 52 based, at least in part, on a comparison of the first reference voltage and the second reference voltage provided by comparator 50. In various embodiments, the second reference voltage is more accurate based on being trimmed (506) that would be the case without being trimmed (506). The second reference voltage is provided (508) as the operation reference voltage to a load, as discussed above.

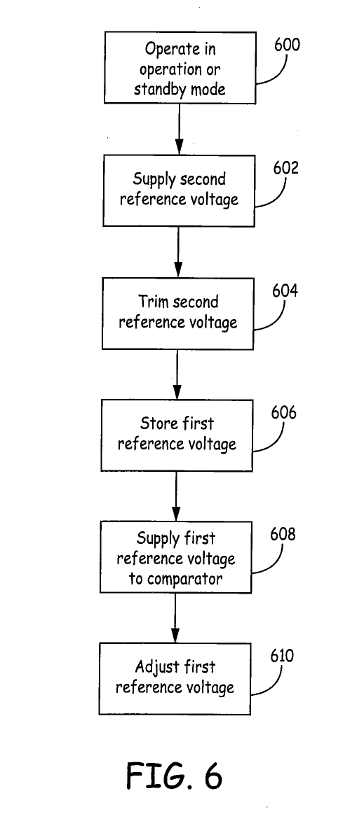

FIG. 6 is a flowchart for an alternative method of providing an operation reference using at least one of voltage supply 46 and voltage supply 146. First reference 10 is variably operated (600) in an operation mode configured to supply the first reference voltage and consume an operation power and a standby mode configured to consume standby power less than the operation power. A second reference voltage is supplied (602) using at least one of second reference 48 and storage circuitry 148, the second reference voltage having a less accuracy than the first reference voltage and consuming a second reference power less than the operation power of first reference 10.

In an embodiment, the second reference voltage is trimmed (604) using trim circuit 52 based upon a comparison by comparator 50 between the first reference voltage and the second reference voltage while operating (600) first reference 10 in the operation mode. In an embodiment, the output of first reference 10, such as a bandgap reference voltage, is stored (606) in storage circuitry 148 and supplied (608) to comparator 50 when first reference 10 is in standby mode. In an embodiment, voltage scaling circuit 18 provides (610) an adjusted bandgap reference voltage from first reference 10 to comparator 50, in an embodiment, the bandgap reference voltage being approximately equal to the threshold reference voltage of second reference 48.

Thus, embodiments of the invention are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A voltage supply, comprising:
a first reference having:
an operation mode configured to supply a first reference voltage at a first accuracy and consume an operation power; and
a standby mode configured to consume standby power less than said operation power;
a second reference configured to supply a second reference having a second accuracy less than said first accuracy of said first reference and which consumes a second reference power less than said operation power of said first reference, said second reference voltage being trimmable based, at least in part, on a comparison of said first reference voltage to said second reference voltage.

2. The voltage supply as in claim 1 wherein said first reference is a bandgap reference.

3. The voltage supply as in claim 2 wherein said second reference is a threshold reference.

4. The voltage supply as in claim 3 wherein said threshold reference is configured with said second accuracy being more accurate with trimming based on said bandgap reference voltage than without trimming based on said bandgap reference voltage.

5. The voltage supply as in claim 4 wherein said operation mode comprises not more than approximately a one percent duty cycle relative to said standby mode.

6. The voltage supply as in claim 4 wherein said operation mode comprises a duty cycle based, at least in part, on an environmental factor.

7. The voltage supply as in claim 6 wherein said environmental factor is temperature.

8. The voltage supply as in claim 6 wherein said environmental factor is change in temperature.

9. The voltage supply as in claim 4 wherein said voltage supply is configured to supply said second reference voltage to a load having a voltage accuracy requirement, and wherein said operation mode comprises a duty cycle based, at least in part, on said voltage accuracy requirement of said load.

10. The voltage supply as in claim 1 wherein said second reference is a threshold reference.

11. A voltage supply, comprising:
a voltage reference having:
an operation mode configured to supply a reference voltage at a first accuracy and consume an operation power; and
a standby mode configured to consume standby power less than said operation power; and
a storage circuit configured to store said reference voltage when said voltage reference is in said operation mode and supply an output voltage approximately equivalent to said reference voltage when said voltage reference is in said standby mode, wherein said output voltage is delivered at a second accuracy less than said first accuracy.

12. The voltage supply as in claim 11 wherein said voltage reference is a bandgap reference configured to supply a bandgap reference voltage.

13. The voltage supply as in claim 12 wherein said storage circuit supplies said output voltage approximately equivalent to said bandgap reference voltage for a supply duration, and wherein said standby mode operates for not longer than said duration.

14. The voltage supply as in claim 12 wherein said storage circuit stores obtains said reference voltage during a storage duration, and wherein said operation mode operates for not longer than said storage duration.

15. The voltage supply as in claim 12 wherein said operation mode comprises not more than a one percent duty cycle relative to said standby mode.

16. The voltage supply as in claim 12 wherein said operation mode comprises a duty cycle based, at least in part, on an environmental factor.

17. The voltage supply as in claim 12 wherein said environmental factor is temperature.

18. The voltage supply as in claim 12 wherein said environmental factor is change in temperature.

19. The voltage supply as in claim 18 wherein said voltage supply is configured to supply said output voltage to a load having a voltage accuracy requirement, and wherein said operation mode comprises a duty cycle based, at least in part, on said voltage accuracy requirement of said load.

20. A voltage supply, comprising:
a first reference having:
an operation mode configured to supply a first reference voltage and consume an operation power; and
a standby mode configured to consume standby power less than said operation power;
a trim circuit having a trim circuit output;
a second reference operatively coupled to said trim circuit and configured to supply a second reference voltage having an accuracy less than an accuracy of said first reference voltage and consume a reference power less than said operation power of said first reference, said second reference voltage being trimmable based, at least in part, on said trim circuit output;
a comparator operatively coupled to said first reference, said trim circuit and said second reference and configured to compare said second reference voltage with a voltage based, at least in part, on said first reference voltage and generate a comparison, wherein said trim circuit output is selectable based, at least in part, on said comparison;
a controller operatively coupled to said first reference and configured to operate said first reference in said operation mode and in said standby mode, with a duty cycle in said operation mode of not greater than approximately one percent;
wherein said first reference voltage is supplied to said comparator and said trim circuit provides said trim circuit output to trim said second reference voltage while said first reference is in said standby mode.

21. The voltage supply as in claim 20 wherein said first reference is a bandgap reference.

22. The voltage supply as in claim 21 wherein said second reference is a threshold reference.

23. The voltage supply as in claim 22 further comprising a storage element, operatively coupled to said bandgap reference and said comparator, configured to store said bandgap reference voltage and supply said bandgap reference voltage to said comparator when said bandgap reference is in said standby mode.

24. The voltage supply as in claim 23 wherein said storage element is a capacitor.

25. The voltage supply as in claim 22 wherein said threshold reference has an operation mode and a standby mode and operates in said operation mode on a threshold reference duty cycle.

26. The voltage supply as in claim 22 wherein said threshold reference duty cycle is at least ten times greater than said duty cycle of said bandgap reference.

27. The voltage supply as in claim 22 further comprising a storage element operatively coupled to said threshold reference and configured to store said threshold reference voltage and provide said threshold reference voltage when said threshold reference operates in said standby mode.

28. The voltage supply as in claim 22 further comprising a voltage scaling circuit operatively coupled to said bandgap reference and said comparator and configured to provide an adjusted bandgap reference voltage to said comparator based, at least in part, on said bandgap reference voltage.

29. The voltage supply as in claim 28 wherein said voltage scaling circuit is a voltage divider.

30. The voltage supply as in claim 28 wherein said voltage scaling circuit is adjustable and configured to selectively provide one of a plurality of adjusted bandgap reference voltage to said comparator.

31. The voltage supply as in claim 22 wherein said adjusted bandgap reference voltage is approximately equal to said threshold reference voltage.

32. The voltage supply as in claim 22 wherein said operation mode comprises a duty cycle based, at least in part, on an environmental factor.

33. The voltage supply as in claim 22 wherein said environmental factor is temperature.

34. The voltage supply as in claim 22 wherein said environmental factor is change in temperature.

35. The voltage supply as in claim 34 wherein said voltage supply is configured to supply said second reference voltage to a load having a voltage accuracy requirement, and wherein said operation mode comprises a duty cycle based, at least in part, on said voltage accuracy requirement of said load.

36. The voltage supply as in claim 20 wherein said second reference is a threshold reference.

37. A voltage supply, comprising:
a voltage reference having:
an operation mode configured to supply a reference voltage at a first accuracy and consume an operation power; and
a standby mode configured to consume standby power less than said operation power; and
a storage circuit comprising a buffer and a capacitive element operatively coupled to said voltage reference and configured to store said reference voltage when said voltage reference is in said operation mode and supply an output voltage approximately equivalent to said reference voltage when said voltage reference is in said standby mode;
wherein said output voltage is delivered at a second accuracy less than said first accuracy.

38. The voltage reference as in claim 37 wherein said voltage reference is a bandgap reference configured to supply a bandgap reference voltage.

39. The voltage supply as in claim 38 wherein said buffer is a first buffer and wherein said storage circuit further comprises a second buffer operatively coupled to said first buffer and said capacitive element.

40. The voltage supply as in claim 38 wherein said buffer supplies said output voltage approximately equivalent to said bandgap reference voltage for a supply duration, and wherein said standby mode operates for not longer than said duration.

41. The voltage supply as in claim 38 wherein said buffer stores obtains said reference voltage during a storage duration, and wherein said operation mode operates for not longer than said storage duration.

42. The voltage supply as in claim 38 wherein said operation mode comprises not more than a one percent duty cycle relative to said standby mode.

43. The voltage supply as in claim 38 wherein said operation mode comprises a duty cycle based, at least in part, on an environmental factor.

44. The voltage supply as in claim 38 wherein said environmental factor is temperature.

45. The voltage supply as in claim 38 wherein said environmental factor is change in temperature.

46. The voltage supply as in claim 45 wherein said voltage supply is configured to supply said output voltage to a load having a voltage accuracy requirement, and wherein said operation mode comprises a duty cycle based, at least in part, on said voltage accuracy requirement of said load.

47. A method of providing an operation reference voltage, comprising the steps of:
operating a first reference in an operation mode configured to supply a first reference voltage at a first accuracy and consume an operation power; and
operating said first reference in a standby mode configured to consume standby power less than said operation power;
providing a second reference configured to supply a second reference voltage having a second accuracy less than said first accuracy of said first reference voltage and which consumes a second reference power less than said operation power of said first reference;
trimming said second reference voltage based, at least in part, on a comparison of said first reference voltage to said second reference voltage; and
providing said second reference voltage as said operation reference voltage.

48. The method as in claim 47 wherein said first reference is a bandgap reference configured to deliver a bandgap reference voltage.

49. The method as in claim 48 wherein said second reference is a threshold reference configured to deliver a threshold reference voltage.

50. The method as in claim 49 wherein said trimming step provides said second accuracy being more accurate with said trimming step based on said bandgap reference voltage than without said trimming step based on said bandgap reference voltage.

51. The method as in claim 50 wherein said operation mode comprises not more than a one percent duty cycle.

52. The method as in claim 49 wherein said operating steps comprise a duty cycle based, at least in part, on an environmental factor.

53. The method as in claim 48 wherein said environmental factor is temperature.

54. The method as in claim 48 wherein said environmental factor is change in temperature.

55. The method as in claim 47 wherein said voltage supply is configured to supply said second reference voltage to a load having a voltage accuracy requirement, and wherein said operating steps comprise a duty cycle based, at least in part, on said voltage accuracy requirement of said load.

56. The method as in claim 47 wherein said second reference is a threshold reference configured to deliver a threshold reference voltage.

57. A method of providing an operation reference, comprising the steps of:
operating a first reference in an operation mode configured to supply a first reference voltage and consume an operation power and in a standby mode configured to consume standby power less than said operation power;
supplying a second reference voltage having less accuracy than said first reference voltage and consuming a second reference power less than said operation power;
trimming said second reference voltage based upon a comparison between said first reference voltage and said second reference voltage while operating said first reference in said operation mode;
wherein said first reference is operated in said operation mode with a duty cycle of not greater than approximately one percent.

58. The method as in claim 57 wherein said first reference is a bandgap reference configured to deliver a bandgap reference voltage.

59. The method as in claim 58 wherein said supply a second reference voltage step is performed by a threshold reference and said second reference voltage is a threshold reference voltage.

60. The method as in claim 58 further comprising the steps of:
storing said bandgap reference voltage; and
supplying said bandgap reference voltage to said comparator when said bandgap reference is in said standby mode.

61. The method as in claim 60 wherein said storage element is a capacitor.

62. The method as in claim 58 wherein said supplying step has an operation mode and a standby mode and operates in said operation mode on a threshold reference duty cycle.

63. The method as in claim 62 wherein said threshold reference duty cycle is at least ten times greater than said duty cycle of said bandgap reference.

64. The method as in claim 58 further comprising the step of providing an adjusted bandgap reference voltage based, at least in part, on said bandgap reference voltage.

65. The method as in claim 64 wherein said adjusted bandgap reference voltage is approximately equal to said threshold reference voltage.

66. The method as in claim 58 wherein said operating step comprises a duty cycle based, at least in part, on an environmental factor.

67. The method as in claim 58 wherein said environmental factor is temperature.

68. The method as in claim 58 wherein said environmental factor is change in temperature.

69. The method as in claim 68 wherein said voltage supply is configured to supply said output voltage to a load having a voltage accuracy requirement, and wherein said operating step comprises a duty cycle based, at least in part, on said voltage accuracy requirement of said load.
